(19) United States
(12) Patent Application Publication
(10) Pub. No.: US 2022/0411896 A1
(43) Pub. Date: Dec. 29, 2022

(54) METHOD FOR RECYCLING LI-ION BATTERIES

(71) Applicant: COMMISSARIAT À L'ÉNERGIE ATOMIQUE ET AUX ÉNERGIES ALTERNATIVES, Paris (FR)

(72) Inventors: Emmanuel Billy, Grenoble (FR); Sandrine Barthelemy, Grenoble (FR)

(21) Appl. No.: 17/754,586

(22) PCT Filed: Oct. 5, 2020
(86) PCT No.: PCT/FR2020/051737

§ 371 Date: Apr. 6, 2022

(30) Foreign Application Priority Data
Oct. 10, 2019 (FR) 1911251

(51) Int. Cl. C22B 47/00; H01M 10/54; C22B 26/12; C22B 3/00; C22B 7/00

(52) U.S. Cl. CPC C22B 47/00; H01M 10/54; C22B 26/12; C22B 23/0461; C22B 7/006

(57) ABSTRACT

A method for recycling a battery including the following steps: a) dissolution of a battery waste, for example an electrode, including lithium and a metal selected from cobalt and manganese, such that a solution to be treated containing lithium ions and metal ions is formed, b) addition of a peroxymonosulfate salt to the solution to be treated, the solution to be treated being regulated at a pH ranging from 1 to 4 when the metal is cobalt or at a pH ranging from 0.1 to 2.5 when the metal is manganese, such that the metal ions are selectively precipitated in the form of metal oxyhydroxide, c) separation of the lithium ions from the solution to be treated. Advantageously, the solution further comprises nickel ions.

### TECHNICAL FIELD

The present invention relates to the general field of recycling of lithium batteries and more particularly to recycling of Li-ion type batteries.

The invention relates to a recycling method allowing selectively extracting cobalt and/or manganese from a solution further containing lithium ions.

The invention is particularly interesting since the efficiency of extraction of these elements is very high.

### PRIOR ART

The market of lithium, in particular Li-ion type, accumulators (or batteries) is currently growing in particular with nomadic applications (“smartphone”, portable electric tooling...) and with the emergence and development of electric and hybrid vehicles.

Lithium-ion accumulators comprise an anode, a cathode, a separator, an electrolyte and a casing which may consist of a polymer pouch, or a metallic packaging. In general, the negative electrode is made of graphite mixed with a PVDF type binder deposited over a copper sheet. The positive electrode is a lithium-ion insertion material (for example, LiCoO₂, LiMnO₂, Li₃NiMnCoO₆, LiFePO₄) mixed with a polyvinylidene fluoride type binder deposited over an aluminium sheet. The electrolyte consists of lithium salts (LiPF₆, LiBF₄, LiClO₄) solubilised in an organic base consisting of mixtures of binary or ternary solvents based on carbonates.

The operation is as follows: during charging, lithium is detached from the active material of the positive electrode and fits into the active material of the negative electrode. During discharge, the process is reversed.

Given the environmental, economic and strategic challenges in the supply of some metals present in batteries, it is necessary to recycle 50% of the materials contained in Li-ion cells and accumulators (2006/66/EC directive). In particular, it consists in valorising copper, cobalt, nickel and lithium.

Currently, to recover the valuable elements, industrials generally use a combination of physical, thermal and chemical methods.

For example, the physical methods consist in dismantling, crushing and sieving the batteries.

The thermal methods are based on pyrometallurgical processes consisting in heating the residues at high temperature to separate the metals in the form of slags or alloys. However, these thermal methods are energy-expensive because they need temperatures that could reach 1400° C. While being very efficient to separate cobalt, nickel and copper, they do not allow recovering manganese and lithium. The chemical methods are used to recover the valuable elements in a pure form. These consist of hydrometallurgical processes implementing reagent in a liquid phase to dissolve and/or make the metals precipitate. The conventional lixiviation uses highly concentrated acids. The separation could be achieved by various chemical methods and reagents.

For example, in the document WO 2005/101564 A1, cells and batteries are subjected to a hydrometallurgical treatment process. The process comprises the following steps: dry crushing, at room temperature, in an inert atmosphere, then a treatment by magnetic separation and densimetric table, and aqueous hydrolysis, in order to recover lithium, for example in the form of carbonate. The fine fraction freed from soluble lithium and including the valuable elements is dissolved in a 2N sulfuric medium at a temperature of 80° C. in the presence of steel shot. After purification, cobalt is recovered by precipitation by adding sodium hypochlorite, with the regulation of pH at a value comprised between 2.3 and 2.8. This method is used for a solution rich in cobalt (>98%) and with a very low manganese concentration (<2%). For a solution that is rich in both cobalt and manganese, an electrolysis is carried out at a temperature of 55° C. under a current density comprised between 400 and 600 A/m².

However, the use of hypochlorite is harmful for the plants, safety and therefore the cost of the process. In addition, it is necessary to know the manganese concentration in order to select the suitable process.

In the document EP 2 532 759 A1, the method for recovering metals from crushings of lithium batteries or of elements of lithium batteries comprising the following steps:

lixiviation of the crushings in an acid medium so as to obtain a solution containing metal ions,

separation of the metal ions from the obtained solution on a first cation-exchange resin, preferably on a sulfonic resin, to obtain a solution of lithium ions, a nickel, cobalt and/or manganese solution, and a last solution of aluminium ions,

separation of the solution of nickel and cobalt and manganese ions on a second cation-exchange resin so as to obtain a solution of nickel and cobalt ions, and a solution of manganese ions.

For example, the elution of the nickel and cobalt ions is carried out with a solution complexing the nickel and/or cobalt ions, for example with aminopolycarboxylic acid.

For example, the elution of the manganese ions is carried out with a mineral acid at a concentration of 2N to 4N.

However, ion-exchange resins are relatively expensive, and need to be regenerated. Their use generates much effluents, significant treatment times and a considerable acid consumption.

In the document US 2019/0152797 A1, a method allowing recovering nickel, manganese, lithium sulphates and cobalt oxides from the battery wastes. The method consists in dissolving battery wastes with acid, iron and aluminium are then retrieved and then calcium, magnesium and copper are retrieved. The separation steps are based on extraction by a solvent and crystallisation by evaporation. The recovered products have a high purity.

However, the extraction by solvent (or liquid/liquid extraction) requires for each element several steps (extraction in the organic solvent, de-extraction of the organic solvent, crystallisation) and therefore involves many products such as kerosene, sulfuric acid and hydrochloric acid. Such a method is long to implement and generates a considerable amount of effluents, it is therefore difficult to industrialise, from an economic and environmental perspective.

### DISCLOSURE OF THE INVENTION

The present invention aims to provide a cobalt and/or manganese extraction method, overcoming the drawbacks of the prior art, and in particular an extraction method that is simple to implement, with a low environmental impact, allowing recovering, rapidly and efficiently, cobalt and/or manganese from a multi-metal solution further containing lithium ions and, possibly, other ions, such as nickel ions.

For this purpose, the present invention proposes a method for recycling a battery including the following steps:

a) dissolution of a battery waste including lithium and a metal selected from cobalt and manganese, such that a solution to be treated containing lithium ions and metal ions is formed,

b) addition of a peroxymonosulfate salt to the solution to be treated,

the solution to be treated being regulated at a pH ranging from 1 to 4 when the metal is cobalt or at a pH ranging from 0.1 to 2.5 when the metal is manganese, such that the metal ions are selectively precipitated in the form of metal oxyhydroxide,

c) separation of the lithium ions from the solution to be treated.

Steps b) and c) may be reversed.

The invention differs from the prior art essentially by the implementation of an oxidising precipitation step during which a peroxymonosulfate salt is used for the selective separation of cobalt and/or manganese.

Only the peroxymonosulfate salt is consumed during the process. Afterwards, the solution to be treated may be subjected to another process, for example, in order to valorise another element present in the solution to be treated.

A synergetic effect is observed between the peroxymonosulfate salt (HSO₅⁻) and the cobalt (II) ions. The peroxymonosulfate and the cobalt (II) ion are active compounds which will react together to form highly oxidant species (like radicals or cobalt (III)) and considerably increase the reactivity of the peroxymonosulfate (by a 10 and possibly 15 factor). The combination of these elements catalyses the selective extraction of cobalt. Cobalt is extracted in the form of a cobalt oxyhydroxide precipitate (CoOOH) which could be easily transformed into cobalt oxide (CoO₂) and valorised.

Advantageously, the battery waste includes both cobalt and manganese. The combination of peroxymonosulfate and cobalt (II) ion catalyses the selective extraction of manganese when the solution contains both cobalt and manganese. Throughout the process, Co(III) ions are generated. These ions will oxidise manganese and enable reduction thereof. Upon completion of the process, cobalt (II) is regenerated. Cobalt is still soluble in the solution throughout the entire process. According to this advantageous embodiment the cobalt ions Co²⁺ may be initially present in the solution or introduced during the process. Manganese is extracted in the form of a manganese oxyhydroxide (MnOOH) precipitate, with Mn(III) and Mn(IV) which could be easily transformed into manganese oxide.

According to this advantageous embodiment, step b) is repeated twice: one time to selectively make the manganese ions precipitate and another time to selectively make the cobalt ions precipitate. Advantageously, the order of the steps is carried out in this order.

Advantageously, the ratio between the cobalt concentration and the manganese concentration ranges from 0.1 to 10 and preferably from 0.5 to 1. Such a range leads to an efficient extraction of manganese while limiting the risks of entrainment.

According to an advantageous variant, the method includes the following successive steps:

step a) as defined before,

a step during which the pH of the solution to be treated in increased and set between 7 and 10, by addition of a base such as NaOH, NH₄OH or Na₂CO₃, such that a precipitate comprising cobalt and manganese is formed,

step c) as defined before,

dissolution of the precipitate comprising cobalt and manganese,

implementation of step b) as defined before by addition of a peroxymonosulfate salt at a pH ranging from 0.1 to 2.5 to selectively make the manganese ions precipitate in the form of manganese oxyhydroxide,

implementation of step b) as defined before by addition of a peroxymonosulfate salt at a pH ranging from 1 to 4 to selectively make the cobalt ions precipitate in the form of cobalt oxyhydroxide.

Advantageously, the battery waste further includes nickel and the dissolution of the battery waste leads to the formation of nickel ions.

According to this embodiment, the method advantageously includes a step during which the pH is increased between 7 and 10, by addition of a base such as NaOH, NH₄OH or Na₂CO₃, such that the nickel ions are precipitated.

Advantageously, the peroxymonosulfate salt is potassium peroxymonosulfate. Preferably, it consists of potassium peroxymonosulfate triple salt.

This compound is stable, inexpensive and is simple to use.

Advantageously, the temperature ranges from 20° C. to 95° C., and preferably from 40° C. to 80° C., for example in the range of 50° C.

Advantageously, step c) is carried out by adding carbonate or with a resin.

Advantageously, the battery waste is a Li-ion battery electrode. Advantageously, it may consist of a nickel-manganese-cobalt (NMC) electrode.

The method has many advantages:

reduce the environmental impact: no generation of toxic gases, a low energy consumption, and a very significant reduction of effluents since, on the one hand, the method does not need acid solutions and, on the other hand, the peroxymonosulfate salt has a very high solubility; a gain of 50% by volume has been noticed,

the method is more efficient in comparison with the methods of the prior art since there is no dilution effect,

the salt dissolved in the solution is very stable in comparison with a mixture of acids,

reduce the treatment cost (price of the salts, reduction of risks for the plants, etc.),

simplify the method and make it more easily industrialisable because the species are not hazardous and are easy to handle,

selectively separate the different metals in presence, in particular in order to valorise them, in particular as in the case of cobalt.

Other features and advantages of the invention will appear from the following complementary description.

It goes without saying that this complementary description is provided only for illustration of the object of the invention and should not in any case be interpreted as a limitation of this object.

### BRIEF DESCRIPTION OF THE DRAWINGS

The present invention will be better understood upon reading the description of embodiments provided for indicative and non-limiting purposes with reference to the appended FIG. 1.

FIG. 1 is a graph representing the evolution of the manganese separation efficiency according to the nature of the ions in the solution, at room temperature for an Oxone® equivalence with respect to manganese, according to a particular embodiment of the invention.

### DETAILED DISCLOSURE OF PARTICULAR EMBODIMENTS

Although this is not limiting in any way, the invention finds particular applications in the field of recycling and/or valorisation of Li-ion type batteries/accumulators/cells, and in particular of their electrodes.

Next, reference will be made to a battery, but it could consist of a cell or of an accumulator.

Next, by battery waste, it should be understood the battery or a portion of the battery that has been recovered after safeguarding and dismantling the battery.

For example, the battery waste comprises lithium as well as cobalt and/or manganese and, possibly nickel. According to a particular embodiment, the battery waste is an electrode whose active material may be LiCoO₂, LiMnO₂ or LiNi_{0.33}Mn_{0.33}Co_{0.33}. (NMC). The NMC electrode may have different nickel, cobalt and manganese rations. For example, the ratio may be 1/1/1 or 6/2/2 or 8/1/1.

The battery waste may further contain other species. The other species may be metals, alkaline metals and/or rare earths. As an illustrative and non-limiting example, mention may be made of the following elements: Fe, Zn, Al, Mg, Cu, Ca, Pb, Cd, La, Nd and Ce.

Advantageously, the battery waste is crushed such that crushings are formed. Alternatively, the method may also be carried out directly on a non-crushed battery waste.

The method for valorising the battery waste comprises at least the following steps:

a) dissolution of the battery waste including lithium and a divalent metal selected from cobalt and manganese, and possibly nickel, such that a solution to be treated is formed containing lithium ions, ions of the divalent metal, and possibly nickel ions,

b) addition of a peroxymonosulfate salt to the solution to be treated, the solution to be treated being set at a pH ranging from 0.1 to 2.5 when the divalent metal is manganese or at a pH ranging from 1 to 4 when the divalent metal is cobalt, such that the ions of the divalent metal are selectively precipitated in the form of metal oxyhydroxide,

c) separation of the lithium ions,

d) possibly separation of the nickel ions.

For example, the steps may be carried out according to the order a), b), c), d) or according to the order a), c), b), d).

According to a first advantageous variant, the method comprises, more particularly, the following successive steps:

dissolution of the battery waste, in an acid medium,

possibly, elimination of the impurities,

separation of manganese, according to the implementation of step b) by addition of a peroxymonosulfate salt at a pH ranging from 0.1 to 2.5 and/or separation of cobalt according to the implementation of step b) by addition of a peroxymonosulfate salt at a pH ranging from 1 to 4,

possibly, separation of nickel, by precipitation in a basic medium,

separation of lithium,

regeneration of the medium.

According to a second advantageous variant, the method comprises, more particularly, the following successive steps:

dissolution of the battery waste, in an acid medium,

possibly, elimination of the impurities,

formation of a manganese and/or cobalt and, possibly, nickel precipitate, by precipitation,

separation of lithium,

dissolution of the precipitate,

separation of manganese, according to the implementation of step b) by addition of a peroxymonosulfate salt at a pH ranging from 0.1 to 2.5 and/or separation of cobalt according to the implementation of step b) by addition of a peroxymonosulfate salt at a pH ranging from 1 to 4,

possibly, separation of nickel, by precipitation in a basic medium,

regeneration of the medium.

The peroxymonosulfate salt, also called monopersulfate or peroxysulfate, is an inexpensive compound with a low environmental impact. The compound is stable, and could be handled without any risk or significant precautions, in contrast with the other processes of the prior art (Cl₂, O₃, SO₂/O₂, . . .). The by-products of the reaction are essentially sulphates which is an advantage, with regards to processes based on chlorides (generation of Cl₂). The oxidising precipitation is selective and efficient.

Preferably, the peroxymonosulfate salt is a potassium peroxymonosulfate salt. It may consist of a triple salt. The formula of the potassium peroxymonosulfate triple salt is 2KHSO₅.KHSO₄.K₂SO₄. For example, such a product is commercialised under the reference Oxone®. It is also possible to use the potassium peroxymonosulfate triple salt commercialised under the reference Caroat®.

It may also consist of a sodium peroxymonosulfate salt. According to a first variant, the peroxymonosulfate salt may be introduced in a liquid form. For example, it is solubilised beforehand in water. It has the advantage of being very soluble in water (250 g/L), which reduces the amount of effluents derived from the process.

According to a second variant, the peroxymonosulfate salt is introduced in a solid form in the solution to be treated. This avoids adding an aqueous solvent in the solution to be treated.

Advantageously, the peroxymonosulfate salt is introduced with a flow rate ranging from 0.1 g per minute per litre of solution (g/min/Lₛₒₗᵤₜᵢₒₙ) to 30 g/min/Lₛₒₗᵤₜᵢₒₙ and preferably from 1 to 10 g/min/Lₛₒₗᵤₜᵢₒₙ.

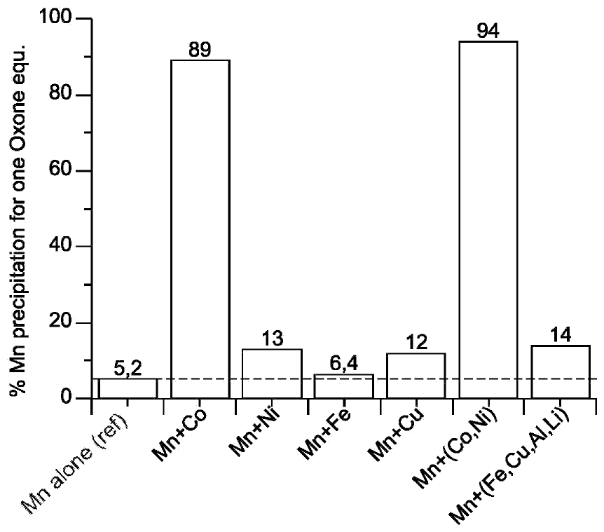

Preferably, the manganese extraction (manganese removal) step is carried out with a solution containing both cobalt ions and nickel ions. Indeed, the efficiency of manganese removal is particularly high when the solution contains both peroxymonosulfate salt and cobalt, and possibly nickel (FIG. 1).

Advantageously, the ratio between the cobalt concentration and the manganese concentration ranges from 0.1 to 10, and preferably from 0.5 to 1. Such a range leads to an efficient extraction of manganese while limiting the risks of entrainment during precipitation.

Preferably, to extract cobalt, a pH from 2 to 3 is selected. For example, a pH in the range of 3 will be selected.

Preferably, the cobalt concentration in the solution is higher than 0.5 g/L and still more preferably higher than 1 g/L. Preferably, the cobalt concentration is lower than 50 g/L and still more preferably lower than 40 g/L to avoid the effects of entrainment which would reduce the purity of the end product.

Preferably, to extract manganese, a pH from 0.75 to 1.5 is selected. For example, a pH of 0.9 will be selected.

Preferably, the manganese concentration, in the solution to be treated, is higher than 0.1 g/L, more preferably higher than 0.5 g/L and still more preferably higher than 1 g/L. Preferably, the manganese concentration is lower than 50 g/L and still more preferably lower than 40 g/L to avoid the effects of entrainment which would reduce the purity of the end product.

To ensure a stable pH, a servo-control is carried out during the introduction of the peroxymonosulfate salt. The servo-control may be carried out with a base such as NaOH, Na₂CO₃ or NH₄OH. The base may be introduced in a liquid or solid form. Advantageously, sodium carbonate in a solid form is selected to reduce the effluents.

To retrieve nickel, the pH is increased between 7 and 10, by addition of a base such as NaOH, NH₄OH or Na₂CO₃, such that nickel is precipitated.

Preferably, the solution is an aqueous solution. It may also consist of an organic solution.

The treatment temperature may range from 20° C. to 95° C., preferably from 30° C. to 90° C., and still more preferably from 40° C. to 80° C. For example, a temperature in the vicinity of 50° C. is selected.

Preferably, the pressure is room pressure (in the range of 1 bar).

The method may include another step during which another element present in the solution to be treated and having a high added value is advantageously recovered.

Illustrative and non-limiting example of one embodiment:

The battery waste (“blackmass”) is primarily composed of cobalt. The composition (in mass percentage) of this waste is provided in the following table:

Composition (%ₘ)

| Li | Ni | Mn | Co | Fe | Al | Cu | Na | K | Ca | Cd | P |
|---|---|---|---|---|---|---|---|---|---|---|---|
| 3.58 | 4.29 | 2.09 | 19.32 | 4.33 | 2.66 | 2.96 | 0.15 | 0.12 | 0.24 | 0.08 | 2.87 |

The remainder corresponds to carbon and oxygen.

During a first step, the waste is dissolved in a sulfuric acid solution with a solid-on-liquid ratio of 15%. The dissolution is carried out at room temperature in 5L of water. The pH is set at 2 thanks to a system for servo-controlling pH which continuously injects sulfuric acid. Afterwards, the medium is left under stirring for one hour. Stirring is ensured at a speed of 400 rpm by a “4 winged” type blade, equipped with a scraper to prevent particle agglomeration.

After dissolution, the pH is raised to 5 with solid sodium carbonate, then 0.35% by volume of hydrogen peroxide (30%) is added, which corresponds to stoichiometric equivalence with respect to iron remaining in the solution. After a stabilisation period of about 30 minutes, the mixture is filtered. A filtrate rich in Li, Ni, Mn and Co and a solid, rich in C, Cu, Fe and Al, are recovered.

The filtrate is then treated in order to selectively eliminate manganese. The considered reaction is an oxidising precipitation, which takes place by continuous addition of solid Oxone®. The oxidant flow rate is 1.5 g/min/L. The pH is continuously set at 0.9 by addition of solid sodium carbonate. Stirring is ensured at a speed of 400 rpm by a “4 winged” type blade. The system is at a temperature of 50° C. The end of the reaction is defined by the duration of addition of Oxone®. The amount of reagent to be added is calculated in order to obtain a stoichiometric equivalence with respect to manganese present in the solution.

Throughout the experiment, breaks are scheduled ever 0.2 Oxone® equivalences: for 15 minutes, the reactant is no longer added in the medium in order to stabilise the system and reach chemical balance. Once the Oxone® total addition is completed, the mixture is filtered. Manganese is completely retrieved from the solution and a filtrate rich in Ni and Co and a manganese dioxide solid with a purity of more than 98% (dosage by an Inductively Coupled Plasma or ICP technique) are obtained.

The filtrate rich in Ni and Co is treated in order to selectively recover cobalt. The considered reaction is an oxidising precipitation, by addition of solid Oxone®, continuously dispensed at 50° C., at a pH set at 3 by addition of solid sodium carbonate. The oxidant flow rate is 1.5 g/min/L. Stirring is ensured at a speed of 400 rpm by a “4 winged” type blade. The end of the reaction is defined by the duration of addition of Oxone®. The amount of reagent to be added is calculated in order to obtain a stoichiometric equivalence with respect to cobalt present in the solution. The ICP dosage of the solid indicates a purity of >99% of the product.

Afterwards, the filtrate is treated in order to extract nickel. The considered reaction is a precipitation in a basic medium in the form of a carbonate. The pH is increased up to 9 by addition of solid sodium carbonate. The reaction takes place at room temperature. Stirring is ensured at a speed of 400 rpm by a “4 winged” type blade.

What is claimed is:

1.-10. (canceled)

11. A method for recycling a battery including the following steps:
a) dissolution of a battery waste, including lithium and a metal selected from cobalt and manganese, such that a solution to be treated containing lithium ions and metal ions is formed,
b) addition of a peroxymonosulfate salt to the solution to be treated, the solution to be treated being regulated at a pH ranging from 1 to 4 when the metal is cobalt or at a pH ranging from 0.1 to 2.5 when the metal is manganese, such that the metal ions are selectively precipitated in the form of metal oxyhydroxide,
c) separation of the lithium ions from the solution to be treated.

12. The method according to claim 11, wherein the battery waste includes both cobalt and manganese.

13. The method according to claim 12, wherein step b) is repeated twice: one time to selectively make the manganese ions precipitate and the other time to selectively make the cobalt ions precipitate.

14. The method according to claim 13, wherein it includes the following successive steps:
step a),
a step during which the pH of the solution to be treated in increased and set between 7 and 10, by addition of a base such as NaOH, NH₄OH or Na₂CO₃, such that a precipitate comprising cobalt and manganese is formed,
step c),
dissolution of the precipitate comprising cobalt and manganese,
implementation of step b) by addition of a peroxymonosulfate salt at a pH ranging from 0.1 to 2.5 to selectively make the manganese ions precipitate in the form of manganese oxyhydroxide,
implementation of step b) by addition of a peroxymonosulfate salt at a pH ranging from 1 to 4 to selectively make the cobalt ions precipitate in the form of cobalt oxyhydroxide.

15. The method according to claim 11, wherein the battery waste further includes nickel, the dissolution of the battery waste leading to the formation of nickel ions.

16. The method according to claim 15, wherein the method includes a step during which the pH is increased between 7 and 10, by addition of a base such as NaOH, NH₄OH or Na₂CO₃, such that the nickel ions are precipitated.

17. The method according to claim 16, wherein the base is NaOH, NH₄OH or Na₂CO₃.

18. The method according to claim 11, wherein the temperature ranges from 20° C. to 95° C.

19. The method according to claim 18, wherein the temperature ranges from 40° C. to 80° C.

20. The method according to claim 11, wherein the peroxymonosulfate salt is potassium peroxymonosulfate.

21. The method according to claim 11, wherein the peroxymonosulfate salt is potassium peroxymonosulfate triple salt.

22. The method according to claim 11, wherein step c) is carried out by adding carbonate or with a resin.

23. The method according to claim 11, wherein the battery waste is a nickel-manganese-cobalt electrode.

24. The method according to claim 11, wherein the battery waste is an electrode.
